(19) United States
(12) Patent Application Publication
(10) Pub. No.: US 2010/0191431 A1
(43) Pub. Date: Jul. 29, 2010

(54) METHOD FOR OPERATING A DRIVETRAIN

(75) Inventors: Rainer Petzold, Friedrichshafen (DE); Peter Herter, Ravensburg (DE); Franz Bitzer, Friedrichshafen (DE); Joachim Staudinger, Ravensburg (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/664,532

(22) PCT Filed: May 27, 2008
(86) PCT No.: PCT/EP2008/056447

§ 371 Date: Dec. 14, 2009

(30) Foreign Application Priority Data
Jun. 30, 2007 (DE) 10 2007 030 493.7

(51) Int. Cl. G06F 19/00

(52) U.S. Cl. 701/68

(57) ABSTRACT

A method for operating a drivetrain comprising an automatic transmission (2) and a power engine (1) such that, in order to carry out a shift operation, in particular an upshift, a clutch (4) connected between the automatic transmission (2) and the power engine is first disengaged and, after carrying out the shift operation, engaged again. A vehicle speed gradient, a transmission input rotational speed gradient, a transmission output rotational speed gradient or a wheel rotational speed gradient is monitored, and after the shift operation has been carried out, the clutch (4) is engaged in such a manner that the gradient being monitored lies within a defined range of values or assumes a defined value.

This application is a National Stage completion of PCT/EP2008/056447 filed May 27, 2008, which claims priority from German patent application serial no. 10 2007 030 493.7 filed Jun. 30, 2007.

### FIELD OF THE INVENTION

The invention concerns a method for operating a drivetrain of a motor vehicle comprising an automatic transmission and a power.

### BACKGROUND OF THE INVENTION

The main components of a motor vehicle's drivetrain are a power engine and a transmission. The transmission converts the traction force provided by the power engine. The present invention concerns a method for operating a drivetrain of a motor vehicle that comprises a transmission in the form of an automatic transmission, and a power engine. The term ‘automatic transmission’ is here intended to be understood as any transmission with automatic or automated gearshifts, and these can also be called multi-step automatic transmissions.

When a gearshift or shift operation is carried out, a clutch of the drivetrain arranged between the power engine and the automatic transmission is first disengaged and then engaged. With automatic transmissions known from practice, when a gearshift or shift operation has been carried out, the clutch is only engaged when a rotational speed difference between a transmission input speed and a power engine speed is smaller than a defined limit value. This can sometimes have the result that after carrying out a gearshift, the clutch is only engaged after a relatively long delay and this has an adverse effect on the shifting quality and the driving behavior. To counteract that, it is also already known from the prior art to brake the power engine so that the speed of the power engine approaches the transmission input speed more quickly, thereby reducing the time before the clutch is engaged. However, this wastes energy.

From DE 100 26 332 A1 a method is known, in which a power engine and a clutch are controlled in co-ordination during a gearshift in such a manner that a nominal value for a clutch torque is established at a point in time as a function of a reference clutch output torque, and a nominal value for the torque of the power engine at that point in time consists of a regulation fraction and a control fraction, such that the regulation fraction is determined from a deviation of a rotational speed of the power engine from a rotational speed trajectory at the said time, and such that the control fraction is established as a function of the rotational speed trajectory at the time, a future course of the speed trajectory and a torque trajectory.

### SUMMARY OF THE INVENTION

Starting from here, the present invention addresses the problem of providing a new type of method for operating a drivetrain of a motor vehicle.

According to the invention, a vehicle speed gradient or a transmission input rotational speed gradient or a transmission output rotational speed gradient or a wheel rotational speed gradient is monitored, and after the gearshift has been carried out the clutch is engaged in such a manner that the gradient being monitored is within a defined range of values or assumes a defined value.

With the method according to the invention, in a simple manner the clutch can be engaged immediately after carrying out a shift operation or a gearshift. Thanks to the method according to the invention a rotational speed difference between the speed of the power engine and the transmission input speed is reduced within a short time with no perceptible adverse effect on shift quality and hence on the driving comfort. By virtue of the method according to the invention, a short load interruption time can be ensured.

Preferably, from a defined value which the monitored gradient should assume when the clutch is engaged, a clutch torque is calculated and the clutch is actuated in such manner that on engagement, it transfers the calculated clutch torque.

### BRIEF DESCRIPTION OF THE DRAWING

Example embodiments of the invention, to which it is not limited, are described in more detail with reference to the drawing, which shows:

FIG. 1: Diagrammatic representation of a drivetrain

### DETAILED DESCRIPTION OF THE PREFERRED EMBODIMENTS

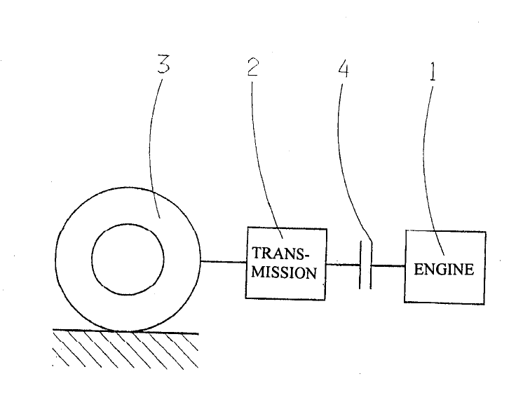

FIG. 1 shows in very simplified form the layout of a drivetrain of a motor vehicle, the drivetrain comprising a power engine 1, an automatic transmission 2 and driven wheels 3 of the motor vehicle. The automatic transmission 2 transfers a traction force produced by the power engine 1 to the wheels 3 of the motor vehicle. An automatically actuated clutch 4 is connected between the automatic transmission 2 and the power engine 1.

The present invention concerns a method for operating such a drivetrain, namely for carrying out a shift operation, in particular an upshift. To carry out a shift operation the clutch 4 is first disengaged, so when a shift operation is carried out a load interruption takes place and after the shift has been completed the clutch 4 must be engaged again. In the sense of the present invention what is now required is to provide a method whereby the clutch 4 can be engaged immediately after a shift operation or gearshift has been carried out, so that the load interruption time is as short as possible.

In the sense of the present invention, for this purpose a vehicle speed gradient, i.e. the vehicle's acceleration is preferably monitored, and once a shift operation has been carried out the clutch 4 is engaged in such manner that the vehicle speed gradient monitored is within a defined range of values or assumes a defined value.

Preferably, the defined value range or defined value is determined as a function of a mass of the motor vehicle and a driving situation of the motor vehicle. In particular, the defined value range or defined value depends on whether the motor vehicle is moving over level ground or on an uphill slope. Furthermore, the defined value range or value preferably depends on whether the motor vehicle is being driven on a road, or off-road.

to control the clutch 4, the preferred procedure is to calculate a clutch torque from the defined value or a value within the defined value range that the monitored vehicle speed gradient should assume when the clutch is engaged. The clutch 4 is then actuated in such manner that on engagement, it transfers the calculated clutch torque.

Instead of the vehicle's speed gradient, a transmission input speed gradient, a transmission output speed gradient or even a wheel rotational speed gradient can also be monitored as alternatives, and when the shift operation has been carried out the clutch 4 is engaged in such manner that whichever gradient is being monitored lies within a defined range of values or assumes a defined value. Then, from the defined value the clutch torque that the clutch 4 should transmit on engagement is again calculated.

In addition, during the engagement of the clutch 4 the torque provided by the power engine 1 can be increased so as to provide the desired gradients when the clutch 4 is engaged.

When during the engagement of the clutch 4 the vehicle speed gradient or one of the rotational speed gradients should be increased, to do this the clutch 4 must be engaged farther. On the other hand, if the vehicle gradient or one of the rotational speed gradients should be made smaller, then to do this the clutch must be disengaged farther. But since a drivetrain is a system capable of fluctuation, it is entirely possible that if the vehicle gradient or one of the rotational speed gradients should be made larger, the clutch 4 of the drivetrain has to be disengaged farther for a short time. Likewise, when the vehicle gradient or one of the rotational speed gradients should be made smaller, the clutch 4 may have to be engaged farther for a short time.

With the method according to the invention, relatively short load interruption times can be achieved when carrying out a shift operation, in particular an upshift. Especially on uphill slopes the fuel consumption can be reduced. Moreover, with the method according to the invention a better acceleration ability of the motor vehicle can be ensured.

Indexes

1 Power engine

2 Automatic transmission

3 Wheels

4 Clutch

1-5. (canceled)

6. A method for operating a drivetrain comprising an automatic transmission and a power engine (1) such that, in order to carry out a shift operation, in particular an upshift, a clutch (4) connected between the automatic transmission (2) and the power engine (1) is first disengaged and, after carrying out the shift operation, engaged again, the method comprising the steps of:
monitoring one of a vehicle speed gradient, a transmission input rotational speed gradient, a transmission output rotational speed gradient and a wheel rotational speed gradient and, after the shift operation has been carried out,
engaging the clutch (4) in such manner that the gradient being monitored at least one of lies within a defined range of values and assumes a defined value.

7. The method according to claim 6, the method comprising the step of determining one of the defined value range and the defined value as a function of a mass of the motor vehicle.

8. The method according to claim 6, further comprising the step of determining one of the defined value range or the defined value as a function of a driving situation of the motor vehicle.

9. The method according to claim 6, further comprising the step of calculating a clutch torque from a defined value which the gradient being monitored should assume when the clutch (4) is engaged and the clutch (4) is actuated in such a manner that, upon engagement, the clutch transmits a calculated clutch torque.

10. The method according to claim 6, further comprising the step of increasing a torque of the power engine during the engagement of the clutch (4).

11. A method of up-shifting a drivetrain of a vehicle comprising an automatic transmission and a power engine, the method comprising the steps of:
disengaging a clutch (4) connected between the automatic transmission (2) and the power engine (1);
monitoring one of a speed gradient of the vehicle, a rotational speed gradient of a transmission input, a rotational speed gradient of a transmission output and a rotational speed gradient of a wheel of the vehicle;
executing a gearshift;
determining, as a function of one of a mass of the vehicle and a driving situation of the vehicle, at least one of a defined value and a defined value range of the one of the speed gradient of the vehicle, the rotational speed gradient of the transmission input, the rotational speed gradient of the transmission output and the rotational speed gradient of the wheel of the vehicle;
adjusting a clutch torque from the power engine (1) to a torque which results in a desired value of one of the speed gradient of the vehicle, the rotational speed gradient of the transmission input, the rotational speed gradient of the transmission output and the rotational speed gradient of the wheel of the vehicle such that the desired value is at least one of equal to the defined value and within the defined range of values upon engagement of the clutch (4); and
engaging the clutch (4).
